(19) United States
(12) Patent Application Publication
(10) Pub. No.: US 2005/0279767 A1
(43) Pub. Date: Dec. 22, 2005

(54) Extension handle with control assembly for aerosol cans

(76) Inventors: Mark R. Kenny, Worth, IL (US); Ronald P. Basick, Orland Park, IL (US)

Correspondence Address: MARK R. KENNY, P. O. BOX 903, WORTH, IL, 60482, US

(21) Appl. No.: 11/141,488

(22) Filed: May 31, 2005

Related U.S. Application Data
(60) Provisional application No. 60/575,939, filed on Jun. 1, 2004.

(51) Int. Cl. B67D 5/64

(52) U.S. Cl. 222/174

(57) ABSTRACT

A swivel handle attachment clamps on the outside diameter of an aerosol can and includes a trigger device which may be remotely activated releasing the contents of said aerosol can by depressing the nozzle from pulling down on a tether. The attachment will adapt easily to a variety of different diameter cans by simply securing the can to a cradle and tightening the clamp. It may be attached to any number of standard male threaded elongated extension polls simply by screwing it onto the handle using the female threaded coupler located at the bottom of the handle. By loosening the thumbscrew the can may be pivoted up or down, making it more accurate in pin pointing contents of said can to targeted area. Removing one self from any dangerous situations. For instance, being up on a ladder while spraying insecticides, or chemicals on trees or buildings and the like.

### FIELD OF INVENTION

This invention relates to aerosol spray cans specifically to elevating aerosol spray cans.

### DESCRIPTION OF PRIOR ART

Many applications require aerosol spray cans elevated beyond ones reach. Presently, an operating device and extension pole device when used in conjunction adapt an aerosol spray can thus making it easier to spray elevated targets.

One such holder which is described in U.S. Pat. No. 4,089,440 to Edward Lee uses multiple clamps and adapters for fastening both his hand held operating device and extension pole to a common spray can but this method only allows the contents of said can to be sprayed unidirectional these devices may be used on various diameter spray cans but the can must first be fitted with the correct adapter ring which requires keeping the inventory of several parts in tact.

### OBJECTS AND ADVANTAGES

Accordingly, several objects and advantages of the invention which obviates the disadvantages of prior aerosol spray can attachments, specifically which is compact in size and can be kept intact, which eliminates the use of multiple parts, which may adapt to vast variety of different diameter cans by simply tightening a modem clamp using a thumb screw, drawing said can into it's cradle, which eliminates the use of tools, re-adjusting the wire trigger to make contact with the spray nozzle, which does not require the use of multiple adapter rings, when mounting to an extension pole it simply screws into a coupler located on one end of the handle opposite of the can, creating a quick connect to most modem and widely used threaded extension poles, which eliminates the use of multiple pole clamps, the can may also be swiveled by loosening a provided hand screw, which enables the can's nozzle to be aimed in a variety of rotated directions, opposed to being unidirectional.

### BRIEF DESCRIPTION OF THE DRAWINGS

FIG. 1 is a exploded view in detail with aerosol can removed.

FIG. 2 is a right sided view with full side detail and cut away view of threaded coupler ref 1:1

FIG. 3 is a right sided view shown pivoting action using phantom lines also showing tether for remote operation.

FIG. 4 is a left side view.

FIG. 5 is a rear view showing cut away view of extension coupler with extension handle screwed in ref 2:2

FIG. 6 is a top view.

### REFERENCE NUMERALS

7 Handle

8 Plastic threaded coupler

9 ¼-20 t.p.i. hex nut

12 Aerosol spray can

13 Die formed wire trigger

14 Hose clamp thumb screw

15a & b Right and left side symmetrical die stamped plate

16 Modem hose clamp

19a, b, c & d Die formed wire guides for wire trigger

20 Can rim for location reference

22 aerosol actuator

23 Elongated bracket slot

27a and b right and left side of die formed cradle

28 Die stamped holes for fastening plates 15a and 15b together

30a,b,c & d are ⅛ inch round semi hollow steel rivets

32 Rectangle hole for clamp

35 String used to activate nozzle

38 Through hole in tang 10a

39 Typical threaded extension pole

40 Through hole in tang 10b

### PREFERRED EMBODIMENT—DESCRIPTION

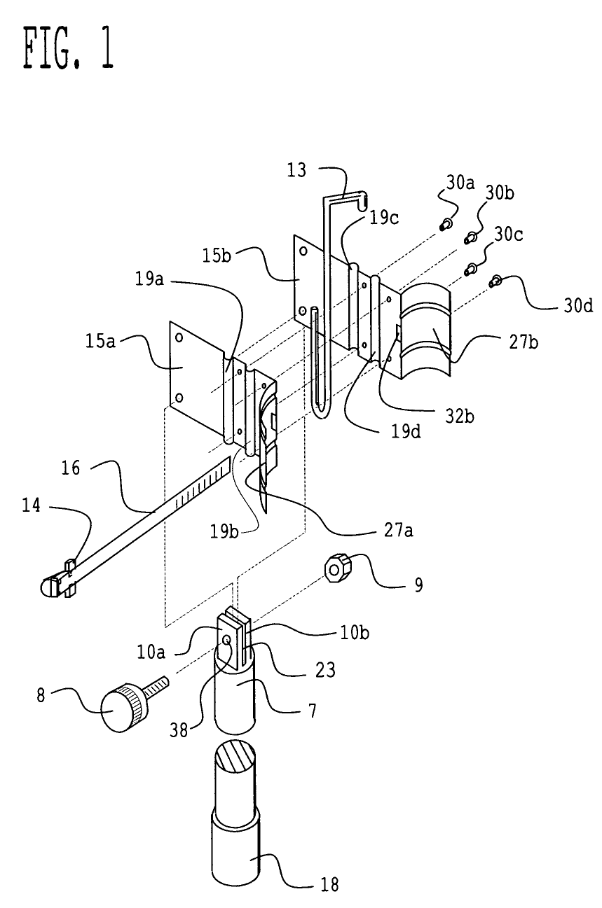

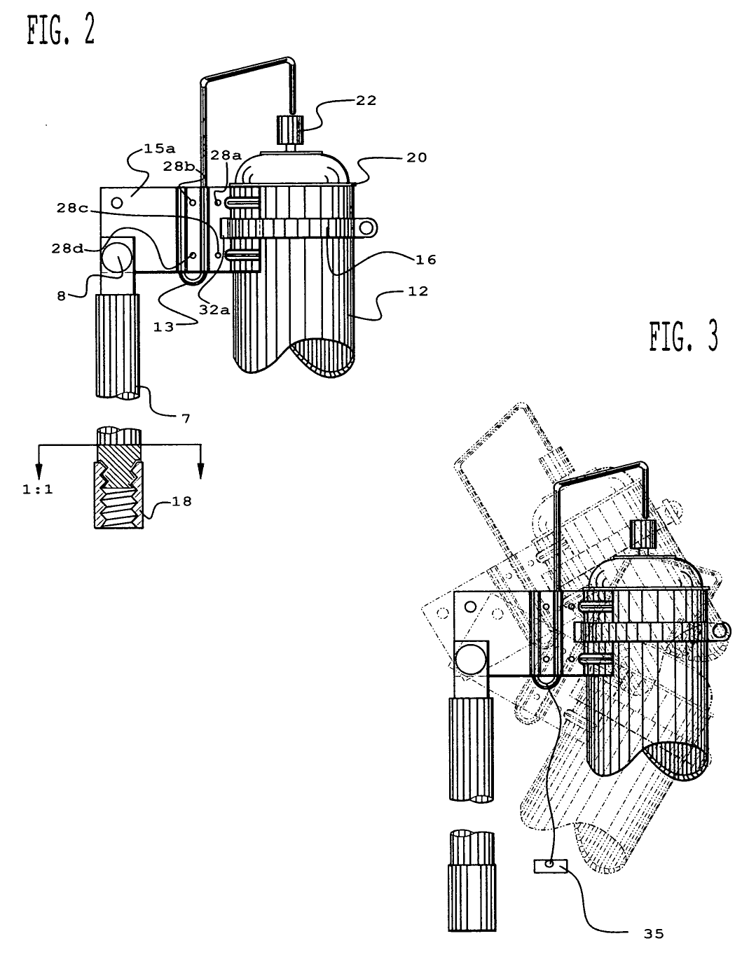

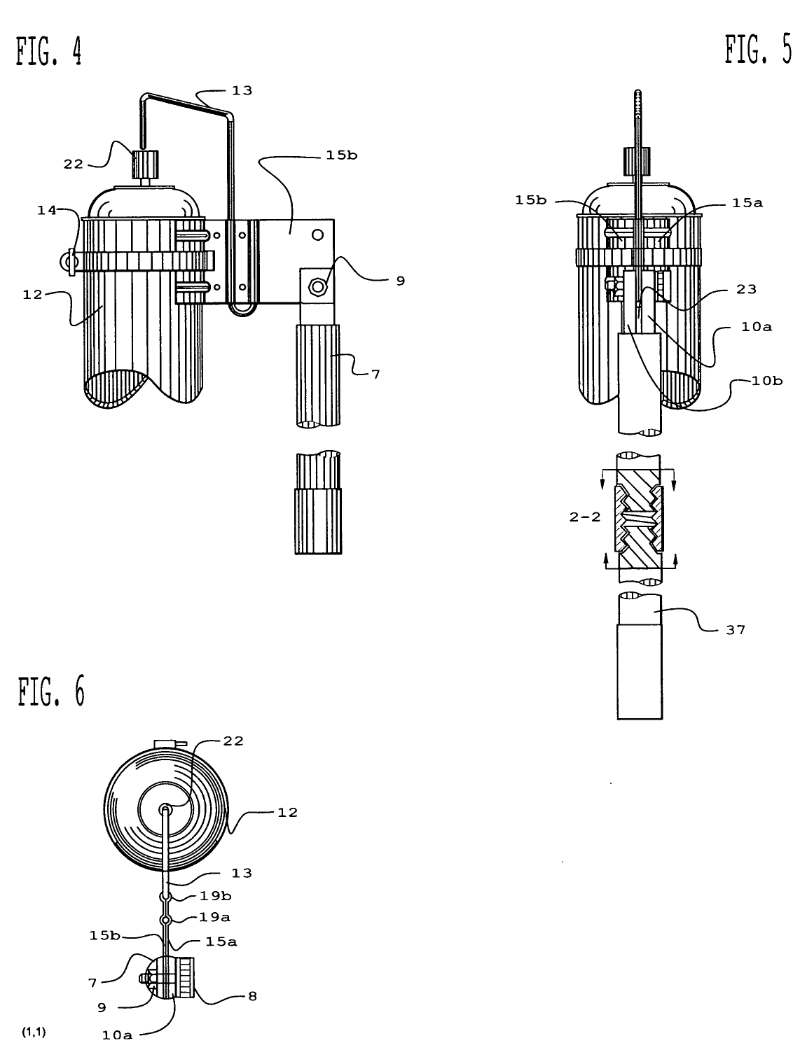

Proceeding therefore to describe the invention in detail, the operating assembly device is preferably made from a soft grade aluminum FIG. 1 15a joined together along with 15b, the handle portion being made from metal, wood or plastic designated 7 extending outwardly and downwardly from one side thereof which engages a molded plastic female threaded coupler FIG. 2 cut away 1-1 showing detail of plastic threaded coupler 8 and FIG. 5 cut away 2-2 showing detail of No 37 conventional threaded extension pole to be attached to coupler extending said can upward beyond ones reach.

The conventional aerosol can is normally cylindrical in configuration and includes the main body portion FIG. 2 collectively designated 12 the domed portion which is terminated by a conventional spray button assembly, collectively designated 22. This spray button assembly includes a depressible spray button and disperser and having a dispensing aperture on one side thereof.

Two symmetrical die stamped plates collectively designated 15a, right side with 15b left side both being 3.70 inches in length and 2 inches in width 0.055 in thickness, extend outwardly from extension handle FIG. 2 no. 7, which are joined together using a series of steel semi hollow rivets ⅛ inch in diameter, collectively designated FIG. 1 30a, 30b, 30c & 30d, which must be inserted into a series of die punched holes FIG. 2 collectively designated 28a, 28b, 28c & 28d, all being 0.128 inches in diameter thus allowing the two said plates to be joined together using rivets 30a thru 30d.

Two semi round trigger guides FIG. 1 collectively designated 19a, 19b, 19c & 19d are die formed in each said plate thereof which run the entire vertical width of said plate.

Two segmented radii are also die formed FIG. 1 27a & 27b, creating a cradle which receives a conventional aerosol spray can FIG. 1 No. 12

Threaded through both sides of the said plates by means of die stamped rectangular hole, 0.575 long and ⅛″ wide, FIG. 1 collectively designated 32a & 32b, which allows camp illustrated in FIG. 1 No. 16 which wraps around the exterior convex portion of said cradle along with said can.

When clamp is tightened using the thumb screw No. 14 creates inward pressure, allowing the engagement of said can into its cradle.

The rim designated No. 20 acts as a reference stop allowing proper location of said can into the receiving cradle.

Prior to joining the two plates together, a pre-formed wire trigger is set into place FIG. 1 No. 13, at that point 15a & 15b is joined together. The trigger No. 13 which is made from ⅛″ diameter stainless wire it consists of three bends all on the same plane, the first bend which creates a shorter length and is a 180 degree bend parallel, which also creates a loop where a random piece of rope or string FIG. 3 No. 35 may be used to activate said nozzle, trigger No. 13 is placed into the parallel guides located on the inside of said plates. The second bend is approximately 110 degrees from the longest portion at the opposite end of wire extending outwardly and upwardly towards the radius center line of the aerosol cans nozzle. The last bend is pointed down towards said nozzle.

The bracket/actuating assembly 15a and 15b can now be inserted into the extension handle No. 7 which is accepted by means of an elongated slot collectively designated 23 which measures 0.100″ wide.

A pre-manufactured thumb screw is inserted into a hole No. 38 which is located in tang No. 10b passing through said bracket which then gets terminated with a ¼-20 t.p.i. hex nut No. 9. When loosened pressure is release allowing said bracket to pivot.

### PREFERRED EMBODIMENT—OPERATION

Operation and use of the remote activated arrangement of the invention is simple and straightforward. When string FIG. 3 No. 36 is pulled downward slides trigger No. 13 onto and depressing nozzle No. 22 releasing contents of aerosol container No. 12. Also shown in FIG. 3. is pivot feature, allowing said can to pivot on a vertical axis rotating up or down by loosening thumbscrew FIG. 1 No. 8 FIG. 5 shows extension handle No. 37 screwed into female coupler FIG. 2 feature No. 18 which must be used to extend operating assembly.

### CONCLUSIONS, RAMIFICATIONS AND SCOPE

Accordingly, it can be seen that a tether arrangement is provided which can connect to a variety of pivoting trigger assemblies. In a durable manner, it can be manufactured with plastic or metal parts it does not extend out and will not unless connected to the proper extension poll. Contents of aerosol container can not compromise the integrity of trigger assembly.

While the above description contains much specificity, these should not be construed as limitations and the scope of the invention, but as exemplifications of the presently preferred embodiments thereof.

Many other ramifications and variations are possible within the teachings of the invention. For example, the handle may be made out of any variety of rigid materials. Aerosol contents may be of vast variety. The trigger may be spring loaded to help return it to its natural state. Thus the scope of the invention should be determined by the appended claims and their legal equivalents, and not by the examples given. centrally within said domed top portion and spray button and dispenser extending upwardly from said spray button assembly; said handle support and operating assembly comprising in combination a centrally located aperture, top portion engaging component and handle extending downwardly from one side thereof, means to engage said component with said cylindrical spray button assembly, a trigger vertically sliding mounted on frame secured to said handle and having an actuating end and spay button engaging end, a cradle segment partially surrounding the outside diameter of said can engages and prohibits any movement of said can by means of tightening a modem clamping device.

1. A handle support and operating assembly for aerosol spray cans which includes a substantially radiused receiver which accepts a cylindrical can with domed top portion, and an upstanding lip between said top portion and the remainder of the can, a cylindrical spray button assembly situated
